(19) United States
(12) Patent Application Publication
(10) Pub. No.: US 2018/0091001 A1
(43) Pub. Date: Mar. 29, 2018

(54) Mitigating False Detection of Foreign Objects in Wireless Power Systems

(71) Applicant: WiTricity Corporation, Watertown, MA (US)

(72) Inventor: David Paul Meichle, Somerville, MA (US)

(21) Appl. No.: 15/719,069

(22) Filed: Sep. 28, 2017

Related U.S. Application Data
(60) Provisional application No. 62/400,827, filed on Sep. 28, 2016.

(51) Int. Cl. H02J 50/60; H02J 7/02; H02J 50/12; B60Q 9/00; B60L 11/18

(52) U.S. Cl. CPC H02J 50/60; H02J 7/025; B60L 11/182; B60Q 9/00; H02J 50/12

(57) ABSTRACT

Methods and systems are provided for mitigating false detection of a foreign or living objects positioned near a wireless power system configured to transmit power to a load of a vehicle. Methods and systems can monitor a foreign or living object detection (FOD or LOD) signal of a FOD or LOD system, the FOD or LOD system coupled to the wireless power system. The methods and systems can receive a first sensor signal from a first sensor and monitor the first sensor signal from the first sensor. Methods and systems can decrease or turn off power transmission, if the first displacement of the FOD signal magnitude crosses the FOD threshold and if the characteristic of the first sensor signal is a normal value throughout time tstart±tolerance, from a wireless power transmitter of the wireless power system.

### CROSS-REFERENCE TO RELATED APPLICATIONS

This patent application claims priority to U.S. Provisional Patent Application No. 62/400,827, filed Sep. 28, 2016, entitled, “Mitigating false detection of foreign objects in wireless power systems,” the disclosure of which is incorporated herein, in its entirety, by reference.

### TECHNICAL FIELD

This disclosure relates to wireless energy transfer and methods for detecting foreign objects near wireless power systems.

### BACKGROUND

Foreign objects can pose a unique threat to the safe and efficient operation of highly-resonant wireless power systems. Foreign objects, particularly those made of conductive materials, can be susceptible to eddy currents that are generated due the magnetic field of the wireless power system. These eddy currents can cause conductive foreign objects to be heated up over time and become hazardous to the wireless power system, the environment, and the user(s) of the wireless power system. In addition to foreign objects, it is also useful to detect living objects in the vicinity of the wireless power system, especially those systems operating at high power. The detection of these objects can be particularly challenging, for instance, in the presence of a vehicle that is being charged by the wireless power system. A further challenge is the real world utility and user-friendliness of such detection systems.

### SUMMARY

In accordance with exemplary embodiments, methods are provided for mitigating false detection of a foreign object positioned within a range of a wireless power system configured to transmit power to a load of a vehicle. The methods can include monitoring a foreign object detection (FOD) signal of a FOD system, the FOD system coupled to the wireless power system; comparing a magnitude of the FOD signal to a FOD threshold to detect a first displacement above the FOD threshold, the first displacement occurring at time tₛₜₐᵣₜ; receiving a first sensor signal from a first sensor positioned within a range of the vehicle, the first sensor separate from the FOD system; monitoring a characteristic of the first sensor signal to determine whether the characteristic is a normal value within time tₛₜₐᵣₜ±tolerance; and decreasing or turning off power transmission, if the first displacement of the FOD signal magnitude crosses the FOD threshold and if the characteristic of the first sensor signal is a normal value within time tₛₜₐᵣₜ±tolerance, from a wireless power transmitter of the wireless power system.

In a related embodiment, the methods can include transmitting an alert to a user of the vehicle, if the first displacement is above the FOD threshold and if the characteristic of the first sensor signal is a normal value within time tₛₜₐᵣₜ±tolerance, wherein the alert includes information about a presence of the foreign object. In another related embodiment, the methods can include comparing a second displacement in the magnitude of the FOD signal to the FOD threshold, the second displacement occurring after the first displacement of the FOD signal magnitude; and increasing or turning on power transmission from the wireless power transmitter, if the second displacement of the FOD signal magnitude is less than the FOD threshold. Optionally, the FOD threshold is predetermined.

In a related embodiment, the tolerance is less than a sampling rate of the FOD system. In another related embodiment, the tolerance is set based on an expected delay in receiving the first sensor signal from the first sensor. In yet another related embodiment, the delay is determined by WiFi latency of a WiFi module in the wireless power system.

In a related embodiment, the first sensor comprises an accelerometer of the vehicle and configured to sense movement of the vehicle, the first sensor signal including accelerometer measurement data, the characteristic being a magnitude of movement of the vehicle. In another related embodiment, the first sensor is an occupancy sensor of the vehicle configured to detect at least one of a door opening, door closing, trunk opening, trunk closing, passenger entering, or passenger exiting, the characteristic being a binary output indicating occupancy in the vehicle. In yet another related embodiment, the first sensor is a temperature sensor of the wireless power transmitter, the first sensor signal being temperature measurement data, the characteristic being a temperature level. Optionally, the first displacement in the FOD signal magnitude is relative to a calibration state of the FOD system and the calibration state before the first displacement is saved to a memory of the FOD system.

In a related embodiment, the methods can include receiving a second sensor signal from a second sensor positioned within a range of the vehicle; monitoring a characteristic of the second sensor signal from the second sensor within time tₛₜₐᵣₜ±tolerance; and decreasing or turning off power transmission from a wireless power transmitter of the wireless power system, if (i) the first displacement of the FOD signal magnitude is above the FOD threshold, (ii) the characteristic of the first sensor signal behaves as expected within time tₛₜₐᵣₜ+/−tolerance, and (iii) the characteristic of the second sensor signal is a normal value within time tₛₜₐᵣₜ±tolerance within time tₛₜₐᵣₜ+/−tolerance. In another related embodiment, the second sensor is a radar-based sensor configured to detect movement in an environment of the vehicle, the second sensor signal being a current or voltage measurement, the characteristic being a magnitude of the current or voltage measurement. Optionally, the radar-based sensor is a Doppler radar-based sensor.

In a related embodiment, the methods can include storing data related to the first displacement in the FOD signal magnitude to a memory module of the wireless power system; and transmitting the data related to the first displacement to an external server system. In another related embodiment, the methods can include storing data related to the displacement of the first sensor signal magnitude of the first sensor in the memory module of the wireless power system; and transmitting the data related to the displacement of the first sensor signal to an external server system.

In accordance with another embodiment, systems are provided for mitigating false detection of foreign objects positioned within a range of a wireless power system configured to transmit power to a load of a vehicle. The systems can include a communication module, coupled to a processor and configured to receive a sensor signal from a sensor positioned within a range of the vehicle. The processor can be configured to: monitor a foreign object detection (FOD) signal of a FOD system, the FOD system coupled to the wireless power system; compare a magnitude of the FOD signal to a FOD threshold to detect a first displacement above the FOD threshold, the first displacement occurring at time tₛₜₐᵣₜ; monitor a characteristic of the sensor signal to determine whether the characteristic is a normal value within time tₛₜₐᵣₜ±tolerance; and transmit a control signal to the wireless power transmitter to decrease or turn off power transmission from the transmitter, if the first displacement is above the FOD threshold and the characteristic of the sensor signal is a normal value within time tₛₜₐᵣₜ±tolerance.

In a related embodiment, the FOD system can include the processor and communication module. In another related embodiment, the wireless power system can include the processor and communication module. Optionally, the processor is configured to transmit an alarm signal to the communication module, if the first displacement is above the FOD threshold and the characteristic of the first sensor signal is a normal value within time tₛₜₐᵣₜ±tolerance, and the communication module, upon receiving an alarm signal from the processor, is configured to transmit an alert to a user of the vehicle, wherein the alert includes information about a presence of the foreign object. In related embodiments, the FOD system is part of an intrusion detection system, where the intrusion detection system includes a living object detection (LOD) system. In related embodiments, the FOD system is part of an environment monitoring and safety system, where the environment monitoring and safety system includes a living object detection (LOD) system.

In accordance with exemplary embodiments, methods are provided for mitigating false detection of a living object positioned within a range of a wireless power system configured to transmit power to a load of a vehicle. The methods can include monitoring a living object detection (LOD) signal of a LOD system, the LOD system coupled to the wireless power system; comparing a magnitude of the LOD signal to a LOD threshold to detect a first displacement above the LOD threshold, the first displacement occurring at time tₛₜₐᵣₜ; receiving a first sensor signal from a first sensor positioned within a range of the vehicle, the first sensor separate from the LOD system; monitoring a characteristic of the first sensor signal to determine whether the characteristic is a normal value within time tₛₜₐᵣₜ±tolerance; and decreasing or turning off power transmission, if the first displacement of the LOD signal magnitude crosses the LOD threshold and if the characteristic of the first sensor signal is a normal value within time tₛₜₐᵣₜ±tolerance, from a wireless power transmitter of the wireless power system.

In a related embodiment, the methods can include transmitting an alert to a user of the vehicle, if the first displacement is above the LOD threshold and if the characteristic of the first sensor signal is a normal value within time tₛₜₐᵣₜ±tolerance, wherein the alert includes information about a presence of the living object. In another related embodiment, the methods can include comparing a second displacement in the magnitude of the LOD signal to the LOD threshold, the second displacement occurring after the first displacement of the LOD signal magnitude; and increasing or turning on power transmission from the wireless power transmitter, if the second displacement of the LOD signal magnitude is less than the LOD threshold. Optionally, the LOD threshold is predetermined.

In a related embodiment, the tolerance is less than a sampling rate of the LOD system. In another related embodiment, the tolerance is set based on an expected delay in receiving the first sensor signal from the first sensor. In yet another related embodiment, the delay is determined by WiFi latency of a WiFi module in the wireless power system.

In a related embodiment, the first sensor comprises an accelerometer of the vehicle and configured to sense movement of the vehicle, the first sensor signal including accelerometer measurement data, the characteristic being a magnitude of movement of the vehicle. In another related embodiment, the first sensor is an occupancy sensor of the vehicle configured to detect at least one of a door opening, door closing, trunk opening, trunk closing, passenger entering, or passenger exiting, the characteristic being a binary output indicating occupancy in the vehicle. In yet another related embodiment, the first sensor is a temperature sensor of the wireless power transmitter, the first sensor signal being temperature measurement data, the characteristic being a temperature level. In yet another related embodiment, the first sensor is a capacitive sensor of the wireless power transmitter, the first sensor signal being capacitive measurement data, the characteristic being a capacitance level. Optionally, the first displacement in the LOD signal magnitude is relative to a calibration state of the LOD system and the calibration state before the first displacement is saved to a memory of the LOD system.

In a related embodiment, the methods can include receiving a second sensor signal from a second sensor positioned within a range of the vehicle; monitoring a characteristic of the second sensor signal from the second sensor within time tₛₜₐᵣₜ±tolerance; and decreasing or turning off power transmission from a wireless power transmitter of the wireless power system, if (i) the first displacement of the LOD signal magnitude is above the LOD threshold, (ii) the characteristic of the first sensor signal behaves as expected within time tₛₜₐᵣₜ+/−tolerance, and (iii) the characteristic of the second sensor signal is a normal value within time tₛₜₐᵣₜ±tolerance within time tₛₜₐᵣₜ+/−tolerance. In another related embodiment, the second sensor is a radar-based sensor configured to detect movement in an environment of the vehicle, the second sensor signal being a current or voltage measurement, the characteristic being a magnitude of the current or voltage measurement. Optionally, the radar-based sensor is a Doppler radar-based sensor.

In a related embodiment, the methods can include storing data related to the first displacement in the LOD signal magnitude to a memory module of the wireless power system; and transmitting the data related to the first displacement to an external server system. In another related embodiment, the methods can include storing data related to the displacement of the first sensor signal magnitude of the first sensor in the memory module of the wireless power system; and transmitting the data related to the displacement of the first sensor signal to an external server system.

In accordance with another embodiment, systems are provided for mitigating false detection of living objects positioned within a range of a wireless power system configured to transmit power to a load of a vehicle. The systems can include a communication module, coupled to a processor and configured to receive a sensor signal from a sensor positioned within a range of the vehicle. The processor can be configured to: monitor a living object detection (LOD) signal of a LOD system, the LOD system coupled to the wireless power system; compare a magnitude of the LOD signal to a FOD threshold to detect a first displacement above the LOD threshold, the first displacement occurring at time tₛₜₐᵣₜ; monitor a characteristic of the sensor signal to determine whether the characteristic is a normal value within time tₛₜₐᵣₜ±tolerance; and transmit a control signal to the wireless power transmitter to decrease or turn off power transmission from the transmitter, if the first displacement is above the LOD threshold and the characteristic of the sensor signal is a normal value within time tₛₜₐᵣₜ±tolerance.

In a related embodiment, the LOD system can include the processor and communication module. In another related embodiment, the wireless power system can include the processor and communication module. Optionally, the processor is configured to transmit an alarm signal to the communication module, if the first displacement is above the LOD threshold and the characteristic of the first sensor signal is a normal value within time tₛₜₐᵣₜ±tolerance, and the communication module, upon receiving an alarm signal from the processor, is configured to transmit an alert to a user of the vehicle, wherein the alert includes information about a presence of the living object.

In accordance with another embodiment, methods are provided for mitigating false detection of a foreign object positioned proximate to a wireless power system configured to transmit power to a load of a vehicle. The methods can include monitoring a foreign object detection (FOD) signal of a FOD system, the FOD system coupled to the wireless power system; comparing a first displacement of the FOD signal from a FOD baseline to a FOD displacement threshold value, the first displacement occurring at time tstart; receiving a first sensor signal from a first sensor; monitoring the first sensor signal from the first sensor, comparing a displacement, within time tstart±tolerance, of a magnitude of the first sensor signal to a first sensor threshold; and transmitting an alert to a user of the vehicle, if the magnitude of the first displacement of the FOD signal from the FOD baseline is greater than the FOD displacement threshold value, and the displacement of the magnitude of the first sensor signal remains below the first sensor threshold within time tstart±tolerance, wherein the alert includes information about a presence of the foreign object.

Related embodiments of the methods can include any of the features described herein.

### BRIEF DESCRIPTION OF THE DRAWINGS

Those skilled in the art should more fully appreciate advantages of various embodiments from the following “Detailed Description,” discussed with reference to the drawings summarized immediately below.

FIG. 1 is a diagram of an exemplary embodiment of a combined foreign object debris and living object detection system.

FIG. 2 is a diagram of an exemplary embodiment of control electronics that include a computer system for detecting foreign object debris and/or living object debris.

FIGS. 3A-3D are diagrams showing example arrangements of wireless power transfer systems.

FIG. 4 is a plot of magnetic field strength in a plane parallel to, and displaced from, the plane of an exemplary transmitter resonator coil.

FIG. 5A is a plot of magnetic field strength in one quadrant of the plot of FIG. 4.

FIG. 5B is a schematic diagram of a detector array in which individual detectors include different numbers of loops.

FIG. 6A shows a diagrammatic representation of an exemplary embodiment of a foreign object detection signal when a foreign object is introduced near the wireless power transmission system.

FIG. 6B shows a diagrammatic representation of an exemplary embodiment of a foreign object detection signal when the vehicle (connected to the wireless power receiver) is moved.

FIGS. 7A-7B show exemplary embodiments of the sensor array of a foreign object detection system.

FIGS. 8A-8C show exemplary embodiments of a wireless power system positioned under a vehicle.

FIG. 9A shows a diagrammatic representation of an exemplary embodiment of a foreign object detection signal when a foreign object is present on or near the wireless power transmission system. FIG. 9B shows a diagrammatic representation of an exemplary embodiment of an output signal from an accelerometer positioned on the vehicle. FIG. 9C shows a diagrammatic representation of an exemplary embodiment of an output signal from a sensor positioned on the vehicle or near the wireless power system.

FIG. 10A shows a diagrammatic representation of an exemplary embodiment of a foreign object detection signal when the vehicle (connected to the wireless power receiver) is moved. FIG. 10B shows a diagrammatic representation of an exemplary embodiment of an output signal from an accelerometer positioned on the vehicle. FIG. 10C shows a diagrammatic representation of an exemplary embodiment of an output signal from a sensor positioned on the vehicle or near the wireless power system.

FIGS. 11A-11B show flowcharts of exemplary embodiments of mitigating false detections of foreign objects.

FIG. 12A shows a diagrammatic representation of an exemplary embodiment of a living object detection signal when a living object is present on or near the wireless power transmission system. FIG. 12B shows a diagrammatic representation of an exemplary embodiment of an output signal from an accelerometer positioned on the vehicle. FIG. 12C shows a diagrammatic representation of an exemplary embodiment of an output signal from a sensor positioned on the vehicle or near the wireless power system.

FIG. 13A shows a diagrammatic representation of an exemplary embodiment of a living object detection signal when the vehicle (connected to the wireless power receiver) is moved. FIG. 13B shows a diagrammatic representation of an exemplary embodiment of an output signal from an accelerometer positioned on the vehicle. FIG. 13C shows a diagrammatic representation of an exemplary embodiment of an output signal from a sensor positioned on the vehicle or near the wireless power system.

FIGS. 14A-14B show flowcharts of exemplary embodiments of mitigating false detections of living objects.

### DETAILED DESCRIPTION

### Introduction

Described herein are methods and systems utilizing foreign object detection (FOD) systems for wireless power transmission systems. Examples of foreign object detection (FOD) systems can be found in U.S. Patent Application Publication 2011/0074346A1 published on Mar. 31, 2011 and titled “Vehicle charger safety system and method”, U.S. Patent Application Publication 2013/0069441A1 published on Mar. 21, 2013 and titled “Foreign object detection in wireless energy transfer systems”, and U.S. Patent Application Publication No. 2014/0111019A1 published on Apr. 24, 2014 and titled “Foreign object detection in wireless energy transfer systems”, U.S. Patent Application Publication No. 2015/0323694A1 published Nov. 12, 2015 and titled “Foreign object detection in wireless energy transfer systems”, and U.S. Patent Application Publication No. 2017/0141622 published May 18, 2017 and titled “Foreign object detection in wireless energy transfer systems” are incorporated by reference herein.

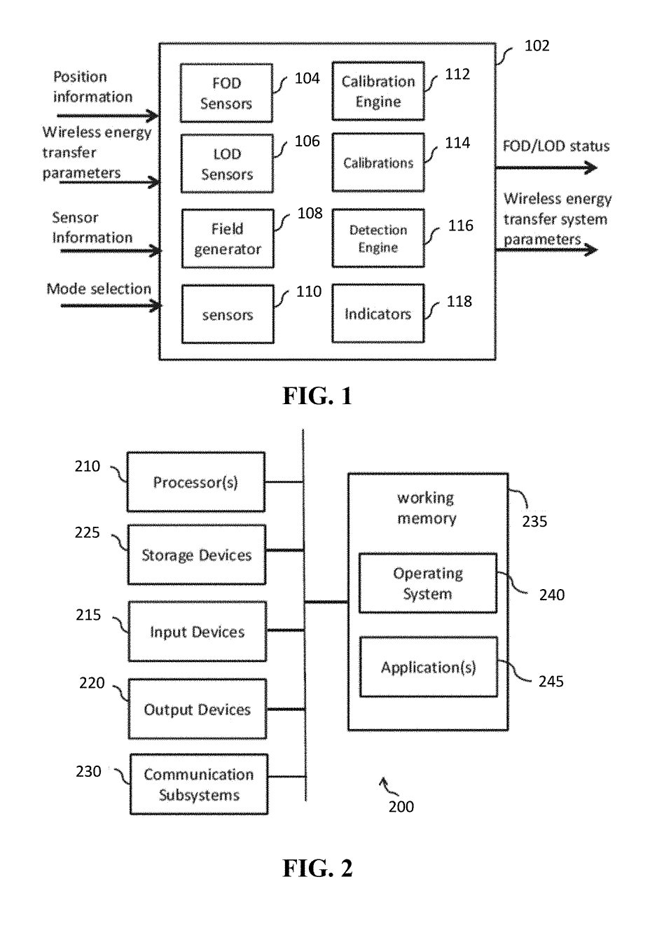

An embodiment of a foreign object debris detection system is shown in FIG. 1. The system may include several modules, block and components that may be used to detect foreign objects and in some embodiments detect living organisms (such as cats, mice, people, etc.) when the objects and organisms are near the resonators used for wireless energy transfer. In some configurations, the FOD system may receive position information from external sensors, vehicle information, or other sources. The position information may include, or may be used, to determine environmental parameters, resonator alignment, resonator distance, positions of wireless energy transfer components, relative position of lossy objects, and position of area with living organisms. Changes in position may be used by the system 102 to change the calibration, adjust sensitivity, detection algorithms, and the like of the system. For example, the field distribution around resonators transferring energy may change depending on the offset of misalignment between the resonators. The change in the magnetic field distribution may change the readings of the FOD sensors in the system and may trigger false positives and/or reduce the sensitivity of system for FOD detection. The system may load new configurations, change processing algorithms, and perform other functions to compensate for changes in sensor readings when position information is received.

In some embodiments, the system may also receive information pertaining to wireless power transfer parameters. The parameters may include data regarding the status of wireless power transfer, how much power is transmitted, at what frequency, phase, and the like. In some embodiments, the system may further receive information from other sensors and system components. The system 102 may receive information from temperature sensors, infrared sensors, pressure sensors, and the like which may be used to change calibrations or baselines used by the FOD system, or to supplement FOD readings.

The FOD system may include one or more FOD sensors and/or LOD sensors. The FOD sensors may include an electrical conductor forming or more loops as described herein. The LOD sensors may include electrical conductors or other capacitive sensors. The FOD and/or LOD sensors may be formed using wires, formed on a printed circuit board, or deposited/printed on resonator packaging or other substrates. The sensors may be arranged and positioned near resonators, near high magnetic fields, near areas where living organisms may be present, and the like. In some embodiments, the sensors may be configured to be positioned a distance away from the resonators, 10 cm away, or even 1 m away. The sensors may be wired, or wireless, receiving power from the wireless power transfer system using wireless communication for data. The sensors may be coupled to read out circuitry that may sample and digitize the sensor readings such that they can be processed by other modules of the system.

In some embodiments, the sensors such as FOD sensors may require an oscillating magnetic field to activate the sensors. The oscillating magnetic field may be generated by a transmitter resonator of the wireless power transfer system. The system 102 may output instructions or indications to elements of the wireless power transfer system to generate magnetic fields using the resonators or change the characteristics of the fields generated by the resonators. In some embodiments, the system 102 may include a field generator 108 configured to generate an oscillating magnetic field to active FOD sensors. The field generator 108 may include one or more loops of a conductor coupled to an amplifier. The amplifier may generate an oscillating voltage to drive the loops and generate a magnetic field.

In some embodiments, the system 102 may be configured to have a calibration mode and a sensing mode that may be selectable based on external input or automatically selected based on sensor readings or the state of other elements of the system. During a calibration mode, the system may gather sensor information and generate a configuration and baseline sensor data.

During the calibration mode of operation, a calibration engine 112 of the system 102 may be used to define a sensor configuration or baseline readings. In some embodiments, the calibration engine may be configured to detect an energy transfer condition. For example, the energy transfer condition may include misalignment, temperature, humidity of the wireless power transfer system. The energy transfer condition may include baseline parameters such as mean matrix, covariant matrix, and likelihood. The calibration engine 112 may include one or more set of procedures and routines for generating a baseline readings. In certain embodiments, the baseline readings may include taking readings from one or more FOD and/or LOD sensors under normal operating conditions with no foreign objects and/or living organisms present. The readings may be taken at different temperatures, orientations, offsets, positions of the resonators and the like. The readings may be used to calculate a baseline which may include calculating a mean and covariance matrix as described in U.S. Patent Application Publication No. 2015/0323694A1, incorporated herein by reference in its entirety. In certain embodiments, a mean and covariance matrix may be calculated for different temperatures, orientations, positions, environmental conditions, and the like. The mean and covariance matrices and other baseline readings and settings may be stored in a calibrations repository 114. Each set of calibrations and baseline readings stored in the calibration repository 114 may be tagged or associated with specific temperatures, resonator positions, environmental conditions, and the like. The positions, power levels, orientations, temperatures, and the like may be received by the system from external sensors and systems. The baseline and calibration files may be, periodically or in response to a user's input, refined and updated. Additional readings from the sensors may be periodically gathered and the mean and covariance matrix periodically updated, for example.

In some embodiments, the calibration engine 112 may be used to define baseline readings in the presence of foreign objects or living objects. The calibration engine may capture sensor readings in various positions, temperatures, orientations, with foreign objects present near the system. The foreign objects and living objects may be used to train the system as to the expected or typical sensor readings when foreign objects or living organisms are present.

During the sensing mode of operation of the system, a detection engine 116 may be used to analyze readings from the sensors to determine if foreign objects or living objects may be present on or near the resonators. The detection engine 116 may receive readings from the sensors 104, 106 and process the readings to determine if the sensor readings are indicative of a foreign object or living organism being present near the sensors. The detection engine may compare the sensor readings to one or more baseline files or calibrations stored in the calibrations repository 114. The comparison may involve calculating a likely system state using the mean and covariance matrices as described herein. The detection engine 116 may receive information pertaining to the system position, temperature, alignment, energy transfer parameters, and the like to select the most appropriate baseline and calibration file. In some embodiments the detection engine may use two or more different baseline and calibration files. The different base line and calibration files may be used to refine a sensor reading, confirm a foreign object detection, reduce or increase sensor sensitivity, and the like. For example, in one embodiment, the system may first use a general baseline that corresponds to a wide range of system positions, misalignments, and the like. When a potential FOD reading is sensed, the system may use a second, different baseline or calibration file to increase the sensitivity or the discrimination of the analysis. The second baseline may correspond to normal sensor readings for a narrow range of system positions and offsets, for example.

In some embodiments, sensing and calibration modes may be run simultaneously. The calibration engine 112 of the system may run simultaneously with the detection engine 116 of the system. If a foreign object or living organisms are not detected, the calibration engine may use the readings to refine the baseline and calibration files.

During the operation of the system 102, one or more indicators 118 may be used to display or signal the status of the system using visual or audio indicators such as lights, graphic or video displays and sounds. When a foreign object is detected, for example, one or more lights may be activated to indicate to a user that possible debris may be located near the resonators. In some embodiments the system may also signal the system and FOD/LOD status to external systems and components. An indication of the system status may be transmitted to a vehicle, for example.

When foreign objects and/or living organisms are detected by the detection engine 116 the system may initiate one or more counter measures to move the foreign object and/or living organism, to adjust the system to avoid the debris, and the like. In one embodiment, the system 102 may signal the wireless energy transfer system to change or adjust the wireless energy transfer. For example, the detection engine may be able to classify or determine the size and impacts of the foreign object or living object, e.g., based on the magnitudes and/or phases of electrical signals generated by foreign object and/or living object sensors. Classifications can include, for example, simple binary classification schemes in which foreign objects and/or living objects are classified as being either “problematic” or “not problematic”. Different threshold values for measured electrical signals can be used for the classification of foreign objects and living objects. Based on the classification of foreign objects, the system 102 may indicate to the wireless energy transfer system to turn down power, change frequency, disable resonators, change resonator configuration and the like. For some foreign objects, for example, energy transfer may at full power (e.g., 3.3 kW) may induce unacceptably high temperatures in the FOD (e.g., 70° C.). Reducing the wireless energy transfer power to half the power may limit the heating of the FOD to less than 70° C. (e.g., less than 60° C., less than 50° C., less than 40° C.), for example. In embodiments, a feedback loop with additional sensors such as temperature sensors, infrared sensors, and the like may be used to adjust the power of the energy transfer to reduce or control the heating of foreign objects or to control the field exposure to living organisms. In another example, in wireless energy transfer systems with two or more transmitter and/or receiver resonators, resonators may be enabled or disabled conditionally on the FOD sensor readings. The resonators for which foreign objects is detected in the vicinity may be disabled or turned down to a lower power while the foreign object-free resonator of the wireless power system may be operated at full power.

It is to be understood that the structure, order, and number of modules, blocks, and the like shown and described in the figures of this disclosure may be changed or altered without deviating from the spirit of the disclosure. Modules may be combined or divided into multiple other modules, for example. For example, a single module may function as a calibration engine module and a detection engine module. The functionality of the modules may be implemented with software, scripts, hardware and the like. For example, the detection engine 116 of the system 102 depicted in FIG. 1 may be implemented as a software module, an application specific integrated circuit, as logic in a field programmable gate array, and the like.

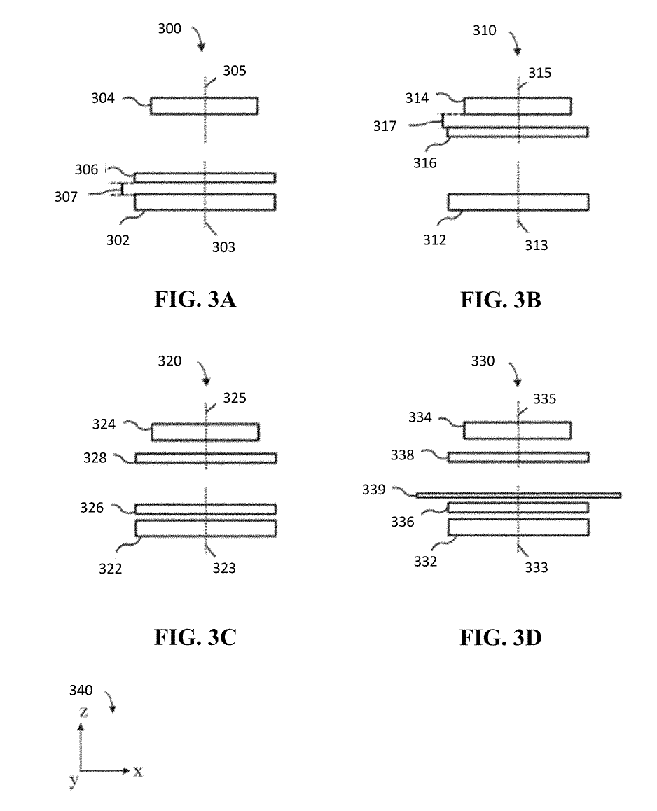

FIG. 2 illustrates an embodiment of a computer system that may be incorporated as part of the previously described computerized and electronic devices such as the FOD/LOD systems, calibration engine, detection engine, etc. FIG. 2 provides a schematic illustration of one embodiment of a computer system 200 that can perform various steps of the methods provided by various embodiments. It should be noted that FIG. 2 is meant only to provide a generalized illustration of various components, any or all of which may be utilized as appropriate. FIG. 2, therefore, broadly illustrates how individual system elements may be implemented in a relatively separated or relatively more integrated manner.

Computer system 200 may comprise hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, video decoders, and/or the like); one or more input devices 215, which can include without limitation a remote control, and/or the like; and one or more output devices 220, which can include without limitation a display device, audio device, and/or the like.

Computer system 200 may further comprise (and/or be in communication with) one or more non-transitory storage devices 225, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

Computer system 200 may also comprise a communications subsystem 230, which can include without limitation a modem, a network card (wireless or wired), an infrared communication device, a wireless communication device, and/or a chipset (such as a Bluetooth device, an 802.11 device, a WiFi device, a WiMax device, cellular communication device, etc.), and/or the like. The communications subsystem 230 may permit data to be exchanged with a network (such as the network described below, to name one example), other computer systems, and/or any other devices described herein. In many embodiments, the computer system 200 will further include a working memory 235, which can include a RAM or ROM device, as described above.

Computer system 200 also may comprise software elements, shown as being currently located within the working memory 235, including an operating system 240, device drivers, executable libraries, and/or other code, such as one or more application programs 245, which may include computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 225 described above. In some cases, the storage medium might be incorporated within a computer system, such as computer system 200. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the disclosed techniques. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer-readable medium, such as one or more of the non-transitory storage device(s) 225. Merely by way of example, execution of the sequences of instructions contained in the working memory 235 might cause the processor(s) 210 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 200, various computer-readable media might be involved in providing instructions/code to processor(s) 210 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 225. Volatile media include, without limitation, dynamic memory, such as the working memory 235.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200.

The communications subsystem 230 (and/or components thereof) generally will receive signals, and the bus 205 then might carry the signals (and/or the data, instructions, etc. carried by the signals) to the working memory 235, from which the processor(s) 210 retrieves and executes the instructions. The instructions received by the working memory 235 may optionally be stored on a non-transitory storage device 225 either before or after execution by the processor(s) 210.

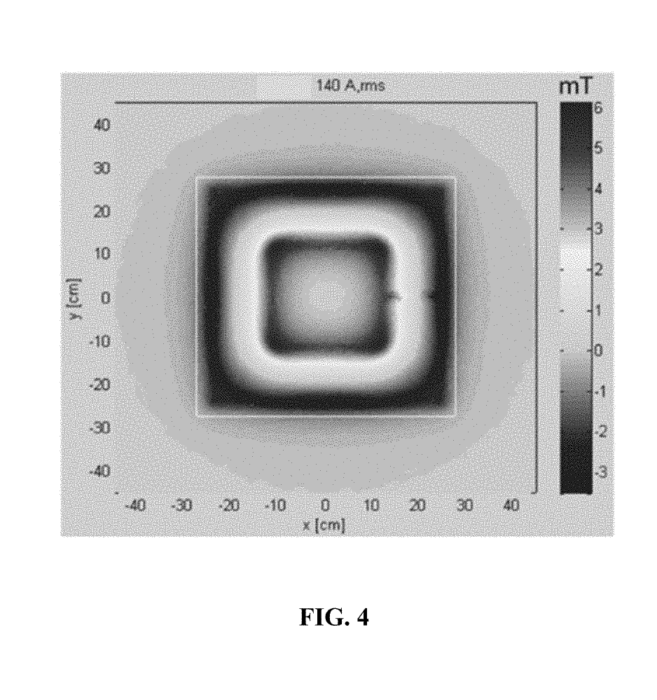

FIGS. 3A-3D are diagrams showing example arrangements of wireless power transfer systems including one or more FOD sensor boards (also referred as “FOD detection sensor boards”) in side views. The one or more FOD sensor boards can be used to detect magnetic field distributions generated by a transmitter coil (e.g., a resonator coil of a power transmitter) or alternatively by an additional coil. Information (e.g. field distribution, field gradient distribution) related to the detected magnetic field can be used to determine misalignment between one or more resonators in a power transmitter and one or more resonators in a power receiver. Coordinate 340 shows the x-direction pointing in the right direction and the z-direction pointing in upward direction of the drawing plane, respectively. The y-direction points into the drawing plane.

In FIG. 3A, arrangement 300 includes a transmitter coil 302 of a power transmitter resonator which can transfer power to a receiver coil 304 (e.g., of a power receiver resonator.) A FOD sensor board 306 is positioned between the transmitter coil 302 and the receiver coil 304. In this example, the FOD sensor board 306 is placed above the transmitter coil 302 with a distance 307 of about 10 mm. In other examples, the distance 307 can be between 3-5 mm (e.g., 4-8 mm, 5-10 mm, 7-12 mm, 10-15 mm, 15-20 mm). The distance 307 can be more than 20 mm. The FOD sensor board 306 can be fixed relative to the transmitter coil 302 by a support structure (not shown), which holds the FOD sensor board 306. For example, the support structure can be one or more poles, which fixes the FOD sensor board 306 relative to the transmitter coil 302. In some embodiments, a dielectric substrate can be placed on top of the transmitter coil 302, and the FOD sensor board 306 can be fixed on top of the dielectric substrate. In the example arrangement of 300, center axis 303 of the transmitter coil 302 and center axis 305 of the receiver coil are aligned with each other. It is understood that when the receiver coil 305 is moved relative to the transmitter coil 302, center axes 303 and 305 become misaligned. In this example, the position of the FOD sensor board 306 relative to the transmitter coil 302 does not change due to the support structures. Accordingly, the FOD sensor board 306 may be referred as a “transmitter-side FOD sensor board.” In some embodiments, the FOD sensor board 306 can be used to determine the misalignment between the center axes 303 and 305 along the x- and y-directions.

In FIG. 3B, arrangement 310 includes a transmitter coil 312 of a power transmitter resonator which can transfer power to a receiver coil 314 of a power receiver resonator. The transmitter coil 312 has a center axis 313 and the receiver coil 314 has a center axis 315. A FOD sensor board 316 is positioned between the transmitter coil 312 and the receiver coil 314. In this example, the FOD sensor board 316 is placed below the receiver 314 with a distance 317 of about 50 mm. In other examples, the distance 317 can be between 5-15 mm (e.g., 15-25 mm, 25-35 mm, 35-45 mm, 45-55 mm). The distance 317 can be more than 50 mm. In this example, the FOD sensor board 316 is fixed relative to the receiver coil 314, and thereby may be referred as a “receiver-side FOD sensor board.” The FOD sensor board 316 can be used determine the misalignment between the center axes 313 and 315 along the x- and y-directions.

In FIG. 3C, arrangement 320 includes a transmitter coil 322 of a power transmitter resonator which can transfer power to a receiver coil 324 of a power receiver resonator. The transmitter coil 322 has a center axis 323 and the receiver coil 324 has a center axis 325. A FOD sensor board 326 (which is a transmitter-side sensor board) is fixed relative to the transmitter coil 326, and a FOD sensor board 328 (which is a receiver-side sensor board) is fixed relative to the receiver coil 324. The FOD sensor boards 326 and 328 can be used either independently or in conjunction to determine the misalignment between the center axes 323 and 325 along the x- and y-directions.

In FIG. 3D, arrangement 330 includes a transmitter coil 332 of a power transmitter resonator which can transfer power to a receiver coil 334 of a power receiver resonator. The transmitter coil 332 has a center axis 333 and the receiver coil 334 has a center axis 335. A FOD sensor board 336 (which is a transmitter-side sensor board) is fixed relative to the transmitter coil 336, and a FOD sensor board 338 (which is a receiver-side sensor board) is fixed relative to the receiver coil 334. In some embodiments, only one of the FOD sensor boards 336 and 338 may be present. The arrangement 330 also includes an additional coil 339 which is fixed relative to the transmitter coil 332. In other examples, the additional coil 339 is fixed relative to the receiver coil 334. The additional coil 339 can generate magnetic fields, which the FOD sensor boards 336 and 338 can detect to either independently or in conjunction with other detectors be used to determine the misalignment between the center axes 333 and 335 along the x- and y-directions.

It is understood that the FOD sensor boards 306, 316, 326, 328, 336 and 338 can include an array of FOD sensors which are described in relation to other figures (e.g., FIGS. 1-27) in this disclosure. In some embodiments, the transmitter and receiver coils can operate between 10 kHz-100 MHz. For example, the transmitter coils can transmit power at approximately 145 kHz. In other embodiments, transmitter resonators may transfer power at approximately 85 kHz, approximately 44 kHz, approximately 20 kHz, approximately 250 kHz, approximately 2.26 MHz, approximately 6.78 MHz and/or approximately 13.56 MHz. In embodiments, the transmitter may have a tunable frequency. For example, a transmitter may operate in a frequency 145 kHz±10 kHz, or 85 kHz±10 kHz. In embodiments, the operating range of frequencies may be ±5%, ±10%, or ±20%, of the center operating frequency. The transmitter and receiver coils can be fabricated from a variety of conducting materials including, for example, Litz wire, solid core wire, copper tubing, copper ribbon and any structure that has been coated with a high conductivity material such as copper, silver, gold, or graphene. In certain embodiments, the FOD sensor boards can have a different shapes and sizes than that of the transmitter and receiver coils. A FOD sensor board can have a larger areal size than the transmitter or receiver coil it is fixed relative to. For example, the FOD sensor board can have width larger by about 5 inches than a width of the transmitter or receiver coil. In some embodiments, the size of a FOD sensor board may be determined by the area of the magnetic field where the field is strongest. In other embodiments, the size and shape of the FOD board may be determined by the area in which certain objects are determined to be heated to undesirable levels, or the size and shape may be set to be larger than such areas by a factor such as 10%, 20%, 50% or 100% in order to provide a certain extra “safety factor” to the overall design. It is also understood that the arrangements 300, 310, 320 and 330 can include shields adjacent to the transmitter coils to reduce energy loss of magnetic fields generated by the transmitter coils. Similarly, the arrangements 300, 310, 320 and 330 can include shields adjacent to the receiver coils to reduce energy loss of magnetic fields induced in the receiver coils.

In some embodiments, that the FOD sensor boards 306, 316, 326, 328, 336 and 338 can be used to determine the distance between the transmitter and receiver coils in the z-direction.

When resonator coils, such as those depicted in FIGS. 3A-3D, are used for wireless power transfer, the spatial distribution of the magnetic fields generated by the coils is an important consideration in FOD and LOD detection systems. In particular, to ensure more accurate detection of FOD and LOD using arrays of detectors as disclosed previously, it can be desirable to ensure that the magnetic flux through each array detector is as nearly equal as possible.

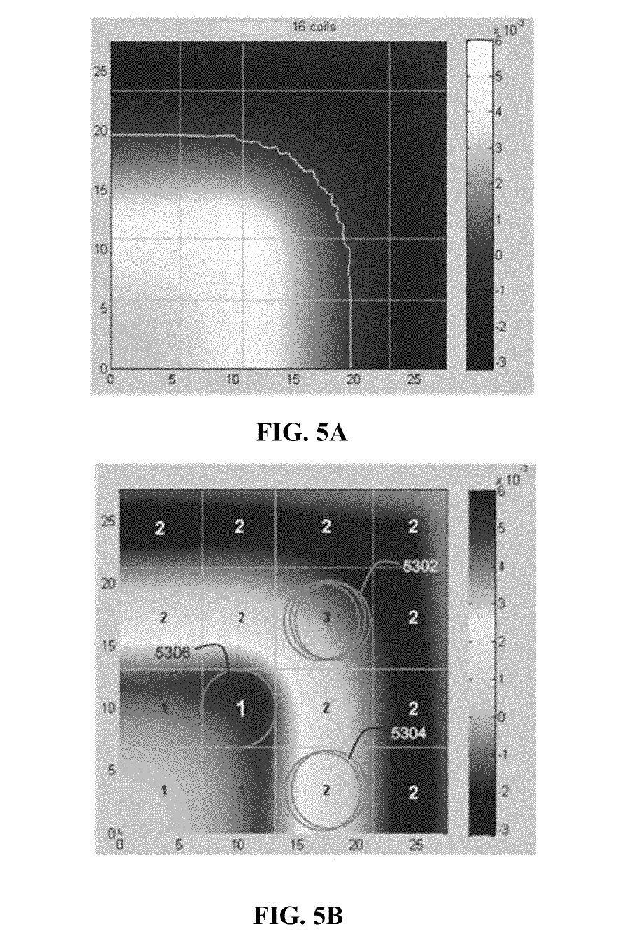

FIG. 4 is a schematic plot showing the simulated magnitude of the magnetic field in the z-direction for a coil similar to coil 4902 or coil 5002. As is evident in the figure, the field magnitude is largest at the corners of coil, i.e., where the density of the coil's conducting elements is largest, and approaches zero in a region outside the boundary of the coil.

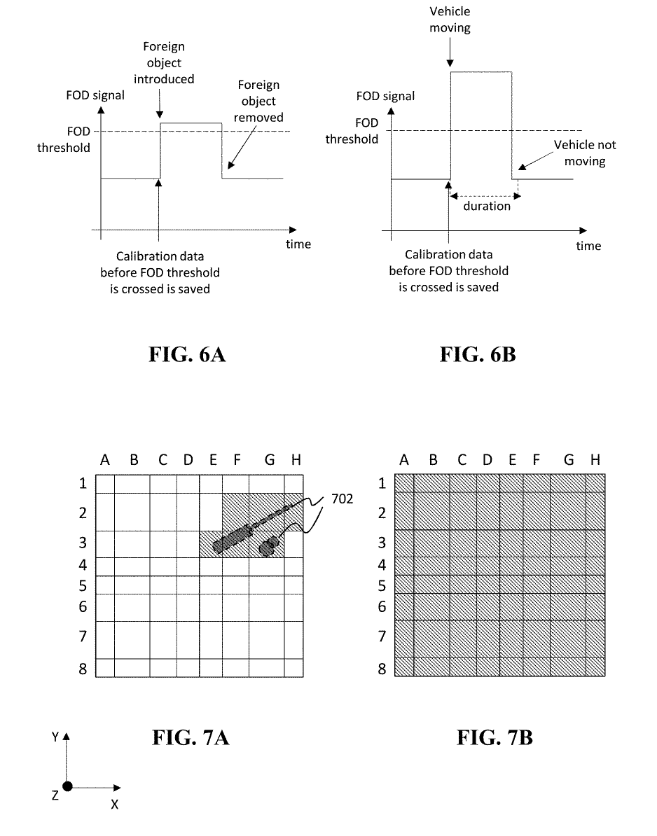

FIG. 5A is a schematic plot showing the simulated magnetic field magnitude at a single corner of the coil shown in FIG. 4. As described previously, in some embodiments, an array of magnetic field sensors can be used to detect foreign objects by measuring the perturbation of the magnetic field between the transmitter resonator and the receiver resonator in a wireless power system. However, it is evident from FIGS. 4 and 5A that if an evenly-spaced array of similarly-sized detectors is used, the flux through certain detectors (e.g., those detectors positioned closest to the corners of the source coil) will be significantly larger than the flux through other detectors.

In general, it can be desirable to minimize the dynamic range of magnetic field flux through the detectors of the array. As described above, one approach to reducing this dynamic range is to use detectors of different cross-sectional areas. In particular, by using detectors of larger cross-sectional area in low-flux regions between the transmitter and receiver resonators, and detectors of smaller cross-sectional areas in high-flux regions, the dynamic range can be reduced relative to an array of equally-sized detectors.

In some embodiments, varying the x- and/or y-spacing between detectors can also be used to reduce the dynamic range of magnetic flux through the detectors of the array. Further, the use of detectors of different cross-sectional areas in addition to different x- and y-spacings can be employed. In FIG. 5A, by using an array of 16 detectors sized according to the vertical and horizontal lines that extend across the plot, a dynamic range of approximately 5 can be achieved.

To further reduce the dynamic range, in some embodiments, detectors having different numbers of loops can be used. FIG. 5B is a schematic diagram showing an embodiment of a FOD/LOD system in which an array of detectors with different numbers of loops is used to reduce the dynamic range of flux through each detector. The quadrant of the transmitter coil shown in FIG. 5B is partitioned into 16 sections, each of which corresponds to a different detector in the array. The numerals superimposed on the figure indicate the number of loops in each detector of the array.

In general, detectors with larger numbers of loops are used in lower flux regions and detectors with smaller numbers of loops are used in higher flux regions. Thus, for example, detector 502 in FIG. 5B—which is positioned in a region of low magnetic flux—has 3 loops. Conversely, detector 506—which is positioned in a region of high magnetic flux—has a single loop. Detector 504, positioned in a region of intermediate magnetic flux, has 2 loops. Note that in FIG. 5B, only detectors 502, 504, and 506 of the array are shown for clarity.

By varying the number of loops in one or more detectors of the array, a reduced dynamic range of magnetic flux can be achieved. For example, using the array shown in FIG. 5B, the dynamic range of magnetic flux can be reduced to a value less than 2, allowing for more sensitive and accurate detection of foreign and/or living objects by the array.

In FIG. 5B, an array of 16 detectors is used to detect flux corresponding to one quadrant of a transmitter coil. Accordingly, four such arrays—each featuring 16 detectors—are used to measure flux from an entire coil. Typically, each of the four arrays is connected to an interface board, and the four interface boards are then connected to a common controller or control board.

In general, detectors with any number of loops can be used in the arrays disclosed herein. For example, FOD sensors with one or more loops (e.g., two or more loops, three or more loops, four or more loops, six or more loops, eight or more loops, 10 or more loops) can be used. In addition, any combination of detectors with different numbers of loops can be used in a particular array for foreign object detection. The detectors can be evenly or differently spaced, and can have the same or different cross-sectional areas, depending upon the particular geometry of the transmitter resonator and measurement constraints.

Further, arrays with any number of detectors can be used for FOD detection. Although the foregoing examples describe the use of four arrays, each with 16 detectors, more generally any number of arrays can be used, each having any number of detectors. In addition, the number of detectors used in different arrays can be the same or different.

### Calibration State and Detection Threshold

In certain embodiments, the baseline and/or the calibration may be calculated for sensor readings that represent the normal and/or acceptable operation of the system. In some embodiments, the sensor readings used to calculate the baseline may be for the FOD free, or fault free, operation of a wireless energy transfer system. The sensor readings used in the calibration of the baseline may represent a partial or complete range of acceptable operating states of a wireless energy transfer system and a partial or complete range of acceptable readings from a FOD detection system.

In general, a wide variety of different operating states for a wireless power transfer system can be represented in baseline and/or calibration information. In some embodiments, for example, baseline information can be provided (e.g., retrieved or measured) for multiple different operating states that correspond to different energy transfer rates between the power transmitter and the power receiver of the system. In certain embodiments, baseline information can be provided for multiple different operating states that correspond to different alignments between the power transmitter and the power receiver for the system.

In an exemplary embodiment, a system calibration state includes a set of basis vectors derived from a first set of electrical signals generated by the plurality of sensors with no foreign object(s) in proximity to the wireless power system. To obtain this calibration state, a second set of electrical signals generated by the plurality of sensors is measured, and a projection of the second set of electrical signals onto the set of basis vectors is calculated. A a detection signal based on the projection of the second set of electrical signals is calculated; the presence of foreign object(s) in proximity to the system is determined by comparing the calculated detection signal to a detection threshold value, and the system calibration state is adjusted based on the presence or absence of foreign object(s) in proximity to the system to generate an updated system calibration state. Many different detection threshold values can be used to perform this comparison. The detection threshold value can updated using an infinite impulse response filter to account for system drift. In embodiments, the detection threshold value may be updated to track a mean of the basis vectors. In embodiments the calculated detection threshold may be a probability threshold and the detection signal is a probability of there being foreign object(s) present near the wireless power transmitter. In embodiments the calculated detection threshold may be a probability threshold and the detection signal is a probability of there not being foreign object(s) present near the wireless power transmitter.

### Mitigating False Detections

Some movements of a vehicle positioned over a wireless power transmitter may trigger a “false detection” of foreign objects by a foreign object detection (FOD) system. Such movements can include shaking, bouncing, leaning, etc. due to wind blowing at the vehicle, people sitting in and/or leaving the vehicle, loading cargo, leaning against the vehicle, and the like. The movement of the vehicle causes the movement of the wireless power receiver (attached to the underside of the vehicle) which itself can cause a significant change in the electromagnetic environment to which the detection system is calibrated. The sensor measurements from the sensor array of the detection system shift away from the calibration state of the FOD system, and the resulting signal appears as an unintended foreign object detection event by the detection system. In many cases, the vehicle may return to its initial position, i.e. the position the vehicle was in before being disturbed by some outside force. While the vehicle itself may not be significantly displaced, the sensitivity of the detection techniques described herein may cause a “false detection” of foreign objects in response to these types of movements. It has been shown that the movement of a vehicle is detected at the detection system by a large displacement in the FOD signal that is somewhat dissimilar to the smaller detection signals of common foreign objects, from tools to coins.

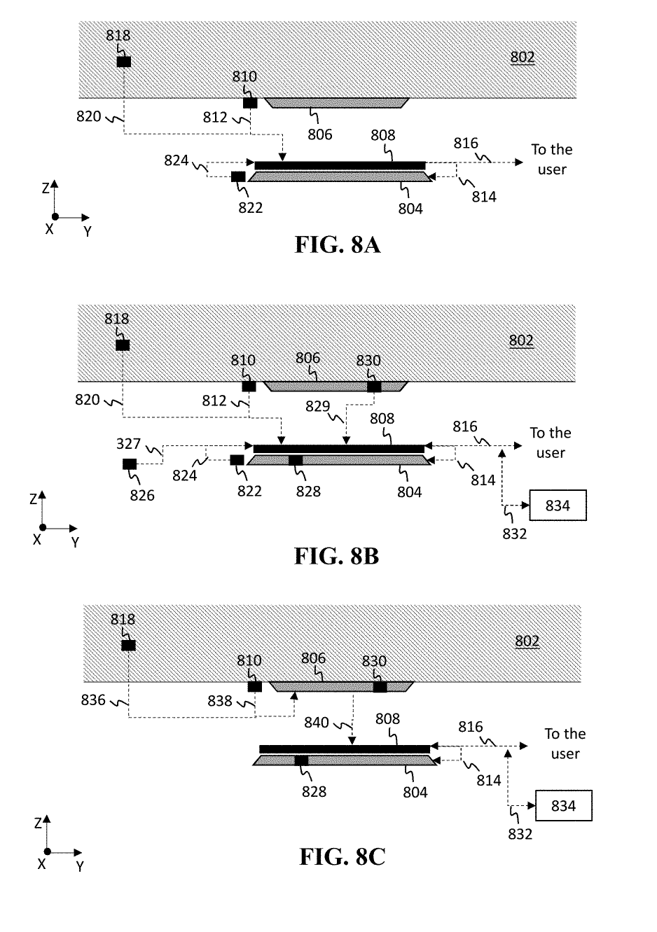

FIG. 6A shows a diagrammatic representation of an exemplary embodiment of a foreign object detection signal when a foreign object is introduced near the wireless power transmission system. Note that the detection signal crosses the FOD threshold when the foreign object is introduced. In some embodiments, the exemplary detection signal may be a raw signal, or some collection of raw signals, from a subset of sensors of the sensor array or the whole sensor array. In other embodiments, the exemplary detection signal is a processed form of one or more signals from a subset of sensors of the sensor array or the whole sensor array. In other embodiments, the value of the FOD threshold is updated during the FOD system calibration. Hence, the value of the FOD threshold may change. In other embodiments, the baseline is above a FOD signal threshold, and the introduction of a foreign object would cause the FOD signal to decrease and cross the FOD threshold (to below the FOD threshold) when the foreign object is introduced. Removal of the foreign object would return the signal to or near the baseline. FIG. 6B shows a diagrammatic representation of an exemplary embodiment of a foreign object detection signal when the vehicle (connected to the wireless power receiver) is moved. Note that the detection signal crosses the FOD threshold and is large compared to the detection signal in FIG. 6A.

In some exemplary embodiments, the foreign object detection system, upon detecting a large signal such as that shown in FIG. 6B, can be programmed to “ride through” a duration of the large signal. This duration can be determined by empirical testing of a vehicle when moved, for example, by actions described above. This duration may be on the order of seconds or minutes to when the vehicle returns to a still position. During this time, in order to ensure safety, wireless power transmission may be decreased or stopped. This can prevent a dangerous situation if a large metallic object (such as a shovel, etc.) is positioned on or near the wireless power transmitter. Once the detection system recognizes that the FOD signal is below the FOD threshold (e.g. when the vehicle comes to a halt), power transmission may resume. Note that in some cases, when a heavy load is placed in the trunk for the duration of charging, the FOD system calibration may take into account the position of the shifted vehicle position. This may result in an initial and end position of the vehicle being different while charging. Thus, the FOD signal may not return to the same level when it stops moving. Note that the value of the baseline FOD signal may change, and the value of the FOD threshold may change.

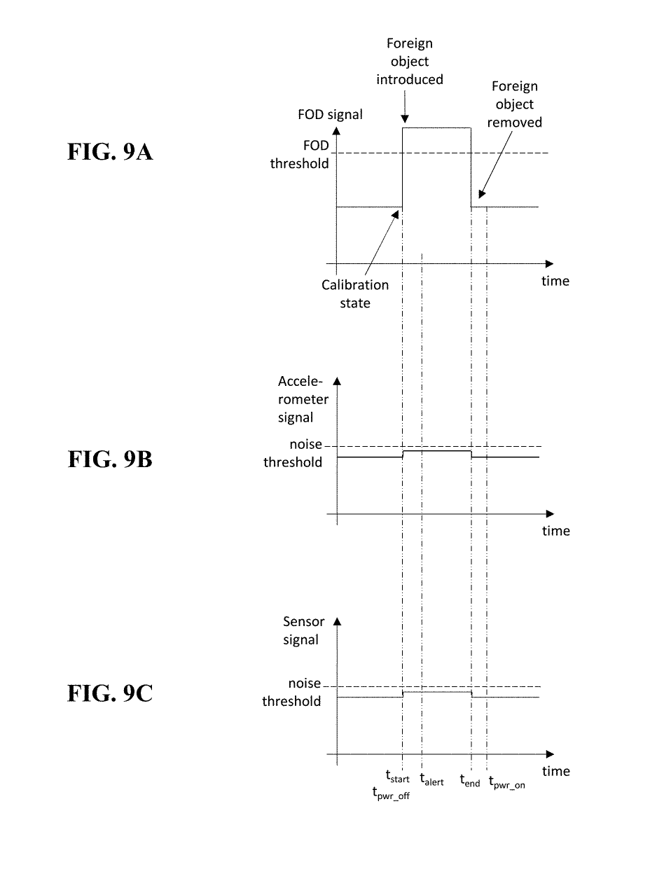

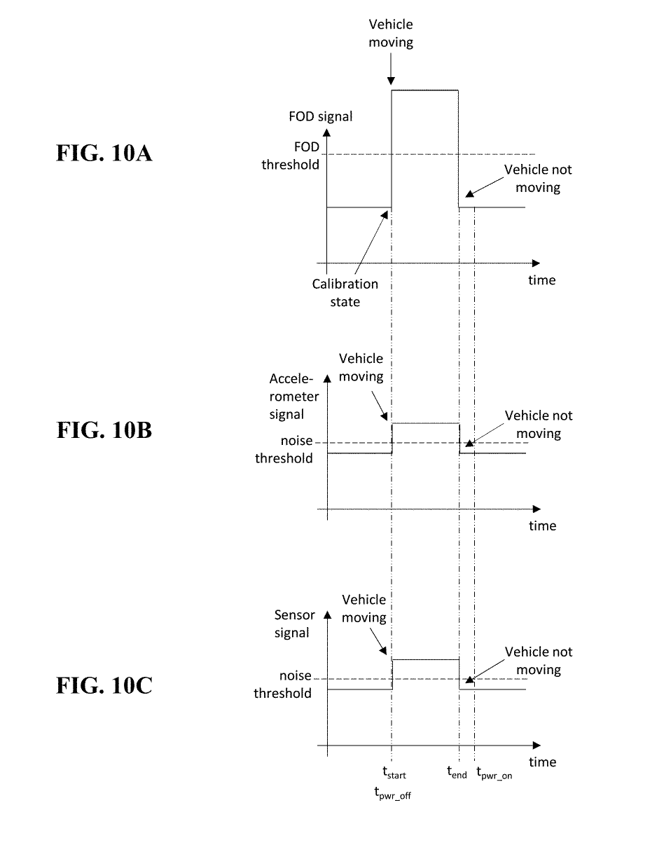

Note also that the detection signal corresponding to the movement of the vehicle may be observed over most or all of the sensors of the sensor array of the detection system. In comparison, a foreign object may cause a few or some of the sensors in the sensor array to detect a change in inductance measurements. FIGS. 7A-7B shows a sensor array of an exemplary FOD system. The sensor array is made of a grid of coils arranged in a plane over the wireless power transmitter 804 (see FIG. 8). These coils may be of different shapes, sizes, and turns depending on the magnetic field shape produced by the wireless power transmitter. FIG. 7A shows that a subset of the sensor array is affected by one or more foreign objects. In the example shown, the sensors that are affected by the foreign objects 202 are sensors with grid labels E3, F2, F3, G2, G3, and H2. FIG. 7B shows that all of the sensors of the sensor array can be affected by the movement of the vehicle.

FIG. 8A shows an exemplary embodiment of a wireless power system positioned under a vehicle 802. The wireless power system includes a wireless power transmitter 804 and wireless power receiver 806. In some embodiments, the sensor(s) of the FOD system 808 may be positioned above or in the wireless power transmitter 804. In other embodiments, the FOD system 808 may be positioned near or in the wireless power receiver 806. The FOD system 808 can communicate with the wireless power transmitter 804 to provide control signal to, for example, turn down or off power transmission when a foreign object is detected. Mounted or otherwise attached to the vehicle can be one or more sensors 810 that can be used to communicate signal 812 to FOD system 808. Sensor 810 can be a preexisting or built-in sensor in the vehicle 802 or sensor 810 can be a positioned near or within the wireless power receiver 806. Exemplary sensors include motion sensors, accelerometers, gyroscopes, radar, optical, ultrasound, or LiDAR. Signal path 812 (dashed line) can include information related to the vehicle to the foreign object detection system 808. In some embodiments, control signals from the detection board, such as the stopping of power transmission, starting of power transmission, alerting the user, and/or other control signals, can be communicated to the wireless power transmitter (or system) via a local control loop 814 and/or to the user of the wireless power system via communication path 816. Communication to the user can include converting detection signals into a notification signal or message to a mobile electronic device (phone, smartphone, laptop, tablet, notebook, smartwatch, wearable, etc.). In some embodiments, communication can also be lights or sounds in the residence connected to the power transmitter. In some embodiments, the detection system may be configured to alert those within a Bluetooth or WiFi range to remove foreign objects near the wireless power transmission system. For example, in a residence with more than one inhabitant, a user may not necessarily be in a reasonable range of the power transmitter to remove the foreign objects and/or confirm that there are no foreign objects. However, another person (such as the spouse or relative of the user) can receive alerts to their mobile electronic device and remove the foreign objects and/or confirm that there are no foreign objects near the wireless power system so that power transmission can resume. In some embodiments, one or more users or persons related to the user can be notified if a detection event is determined by the detection system to be a false positive detection. For example, the user of the system may receive a first alert to the presence of a foreign object on or near the wireless power system. In the meantime, one or more sensors may establish that the detection event was false and transmit a second alert notifying the user that the detection was false. This may be an especially desirable feature for a user who is a considerable distance away from his or her vehicle and its wireless power system and would not want to arrive at his or her vehicle only to discover that no foreign objects were present proximally to the system.

In some embodiments, a mechanical or electromechanical technique may be used to remove foreign objects away from the wireless power system. These techniques can include robots, wipers, and the like in the place of human intervention. In some embodiments, the FOD system can initiate the removal of the objects without alerting a human and continue foreign object detection to make sure that the foreign object was removed. In the event of a false positive foreign object detection, in some embodiments, the FOD system can discontinue the removal of the foreign object.

In some exemplary embodiments, the sensor 810 can be an accelerometer that can signal or communicate with the foreign object detection system. For example, the foreign object detection system may sense the movement of the vehicle via a large foreign object detection signal if cargo is loaded into the trunk. The accelerometer can signal to the detection system that the vehicle itself is moving or has moved. Taking this input from the accelerometer, the foreign object detection system may override its false positive detection of a foreign object. In some embodiments, the foreign object detection system may be trained over time that such small movements of the vehicle can be disregarded. For example, if wind causes a particular vehicle to move or vibrate at a specific frequency, the accelerometer on the vehicle will output a signal indicating the movement of the vehicle with a certain magnitude at a particular frequency or frequencies. The FOD system (which may receive this output signal) or the accelerometer itself can be trained to calibrate out those specific frequencies or signals. In other words, the FOD system or other system can be trained to sort out or disregard these specific frequencies or signals. In a specific embodiment, the accelerometer can be trained to identify the certain magnitude at the particular frequency or frequencies as the vehicle moves due to the wind. Taking this input from the accelerometer, the FOD system may override its false positive detection of a foreign object. The FOD system can also be trained, by looking for particular patterns of data from the FOD sensors during the wind event. It may be the pattern is global variation in FOD signals with a certain characteristic of variation. In some embodiments, either or both of the FOD system and accelerometer outputs can be received by the processor of the wireless power system (for example, the transmitter) for analysis. In some embodiments, the data that is calibrated out can be saved to a memory of the system to generate training data for use in training the sensor(s). Note that if the vehicle moves significantly, the coupling between the transmitter resonator and receiver resonator can be affected resulting in a lower efficiency. In such a case, power transmission can stop and the user may be notified to realign the vehicle to improve efficiency. If, for example, the vehicle has autonomous parking functionality, the vehicle can realign itself to improve the coupling between the transmitter and receiver resonators.

In some embodiments, the FOD system can take in more than one sensor input from the vehicle. For example, some vehicle sensors 818 such as door, hood, suspension, and trunk opening sensors or occupancy sensors in the passenger seats can be utilized as part of the detection system. For example, when a door is opened on the vehicle, the resulting shift in the measurements (e.g. inductance, magnitude, phase, and the like) made by the FOD sensor array can cause false positive foreign object detection. In this case, one or more sensors found on most modern vehicles to indicate an open door can provide input to FOD system via signal path 820. In another example, the trunk may be opened and cargo may be put in (or taken out of) the trunk; the weight difference can cause a positional shift of the vehicle 802, for example, in the Z-direction and result in false positive foreign object detection. In this case, one or more sensors to indicate that the trunk is open can provide input to the FOD system.

In another example, a person getting in and out of the vehicle can cause a positional shift of the vehicle 802 can result in false positive foreign object detection. A weight sensor in a passenger seat can provide information to the foreign object detection system to indicate that a person is entering/exiting the vehicle. In other embodiments, the user of the vehicle can receive a notification, via a user interface inside the vehicle or mobile electronic device, from the detection system asking whether the vehicle was moved (for example, by opening a door or putting cargo into the trunk). The user can confirm or deny via the user interface that they may have moved the vehicle. The detection system can take this information into account to determine whether a false detection occurred. Redundancy via two or more sensors can ensure that the user of the wireless power system is not unnecessarily alerted, creating a less desirable user experience.

FIG. 8B shows the exemplary embodiment of the wireless power system from FIG. 8A, including at least one additional sensor. The at least one additional sensor can include sensor 826 which is positioned within a range to the wireless power system and can measure, collect, and/or process information about the environment of the wireless power system. In some embodiments, the sensor 826 may be positioned within 10 feet of the wireless power system, within the area under the vehicle that covered by the vehicle chassis, under the ground, in the garage or lot configured to house the vehicle, and the like. In some embodiments, the range within which sensor 826 is positioned may be determined by its ability to sense the presence of foreign or living objects. If sensor is a thermal sensor, it may be positioned to detect a change in temperature in or near the wireless power system or vehicle. If the sensor is an optical sensor, the sensor may be positioned depending on its ability to optically resolve the presence of an object. Exemplary sensor(s) include motion sensor, radar, optical sensor, ultrasound, LiDAR, inductive sensor, capacitive sensor, thermal sensor, humidity, barometric pressure, anemometer, accelerometer, gyroscope, and/or acoustic sensor.

In this example, because sensor 826 is spatially removed from the wireless power transmitter and/or the vehicle, sensor 826 measurements may be able to collect other types of information that, for example, other sensors may not. In other words, its distance from the wireless power system can be used as an advantage to reduce influence of the wireless power field on sensor measurements. Likewise, effects of the vehicle may also be reduced depending on the position of sensor 826. For instance, sensor 826 may be able to measure environmental temperature which may provide different results than a temperature sensor positioned on or closer to the wireless power transmitter (for example, in the position of sensor 822). This can be true for any other type of sensor, such as wind, water, humidity, and the like. In this example, a temperature sensor that is positioned on, in, or very near the wireless power system may be affected by the temperature of the wireless power transmitter itself, such as during power transmission. In some embodiments, sensor 826 can detect the information about the environment more accurately. Sensor 826 may also provide redundancy in terms of power supplied to the sensor, in case of a malfunction, or in case loss or absence of power occurs for sensors powered by the wireless power transmitter, wireless power receiver, or the vehicle battery.

Some embodiments of the wireless power system can include other sensors 828 and/or 880 that are positioned on or in the transmitter 804 and receiver 806, respectively. One or more of these sensors may also provide additional information that may not otherwise be available from other sensors. For example, a sensor 828 is able to provide information about the inner temperature of the transmitter that an external temperature sensor may not be able to gauge. In some embodiments, the outputs of these sensors may be electronic signals such as current, voltage, and/or power (including information such as magnitude, phase, and/or frequency information). In other embodiments, the outputs of these sensors may be binary, such as on/off, or in the example of an occupancy sensor, a passenger sensed or not. Sensors 828 and/or 880 may be any of the type described herein for sensors 810, 822, 826, but may provide information from the vantage point of the wireless power transmitter or receiver, respectively. For example, sensor 828 may be a pressure sensor or weight sensor that detects the weight of a foreign object that may be positioned on the transmitter 804. As an additional example, the position of sensor 828 (or geometric arrangement of multiple sensors 828) in the transmitter may be controlled at the time of assembly of the transmitter 804 as compared to the placement of, for example, sensor 826, which may be positioned at the time of installation and may have more freedom and less accuracy, in its placement. These different degrees of freedom may be addressed by combination or fusion of sensor measurements or outputs. Such considerations are applicable to the receiver sensor 830. For example, the shaking, tilting, or leaning of the vehicle may be determined by comparing vehicle height data from optical or ultrasonic sensors. Sensor 830 may operate in combination with sensors 822, 828, or 826 to determine such vehicle movement, shaking, tilting, and/or leaning. For example, the distance between one or more radio, electromagnetic, acoustic, and/or optical sensors 830 and 828 can help determine such vehicle movement, shaking, tilting, and/or leaning. Communication paths 827 and 829 may couple information from sensor 826 and 830, respectively, to the detection system 808. One or more of these communication paths may be wired or wireless. Note that any of the communication paths (dashed lines) shown in FIGS. 8A-8C may communication directly with the wireless power transmitter 804.

FIG. 8C shows another exemplary embodiment of a wireless power system. In some embodiments, a communication path 836 is established between sensor 818 to the wireless power receiver 838. In some embodiments, a communication path 838 is established between sensor 810 to the wireless power receiver 838. In each case, the receiver 806 may take measurements or data from sensors 818 and 810 and transmit the information to the transmitter 804, via communication path 840. In some embodiments, the receiver 806 can include a processor configured to process the data from one or more of sensors 818, 810 before sending to the transmitter 804. The processor may be coupled to a communication module, such as a WiFi, Bluetooth, or radio enabled module, configured to send this data. Note that while not every sensor from FIGS. 8A and 8B are shown in FIG. 8C, it is understood that any of the previously described sensors may be in the embodiment illustrated in FIG. 8C. One or more of these communication paths 838 and 836 may be wired or wireless.

In an exemplary use case scenario, the user of the system is notified of a false detection event and checks near the wireless power system to remove the foreign objects so that power transmission may resume. If no foreign objects are present, the user may, over time, not trust the system to correctly detect foreign objects. This may cause the user to ignore possible true detection events and/or discontinue use of the wireless power system due to the inconvenience of checking for foreign objects in response to false detections. Further, if power transmission stops over the time that the user is expecting their vehicle to be charged (for example, charging overnight to be road-ready in the morning for work) due to false detections of foreign objects, this can cause user dissatisfaction.

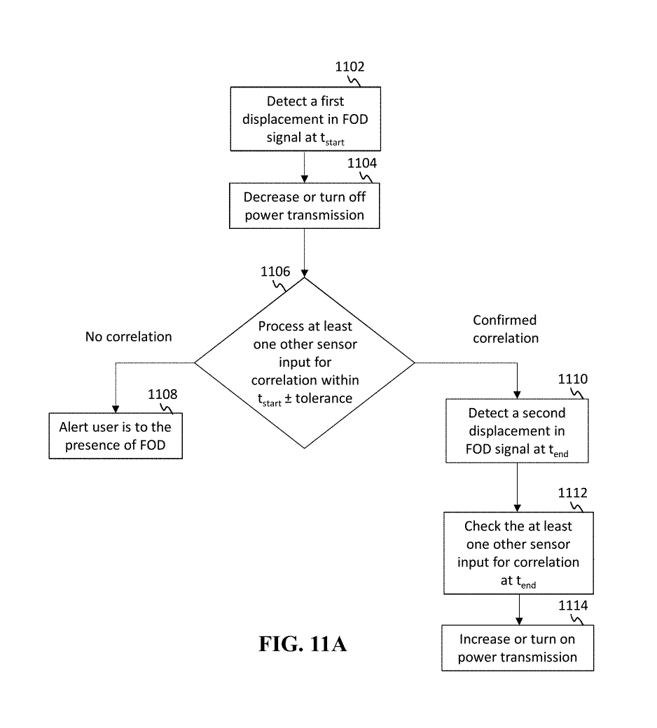

FIG. 9A shows a diagrammatic representation of an exemplary embodiment of a foreign object detection signal when a foreign object is detected. Note here that the FOD signal is greater than the FOD threshold at time tₛₜₐᵣₜ. The FOD threshold may be predetermined or may be customized for the vehicle type, power level, environment, etc. FIG. 9B shows a diagrammatic representation of an exemplary embodiment of an output signal from an accelerometer positioned on the vehicle 202. Note that the accelerometer signal is less than the accelerometer “noise” threshold at time tₛₜₐᵣₜ.

FIG. 9C shows a diagrammatic representation of an exemplary embodiment of an output signal from a sensor positioned on the vehicle or near the wireless power system. Note that the sensor signal is less than the sensor threshold at time tₛₜₐᵣₜ. The thresholds for the accelerometer and/or other sensor(s) may be determined by empirically measuring noise in a typical environment, such as a garage or lot. Note that after some delay (time tₐₗₑᵣₜ-time tₛₜₐᵣₜ), the user can be alerted to the presence of a foreign objects at time tₐₗₑᵣₜ. In some embodiments, the user may be alerted at tₛₜₐᵣₜ (such that time tₐₗₑᵣₜ approximately equals time tₛₜₐᵣₜ). Once the foreign object is cleared, there may be some delay (time t_{pwr}_{_}ₒₙ-time t_{end}) before power transmission is turned back on at time t_{pwr}_{_}ₒₙ.

Note that because the information from an accelerometer and/or sensor on the vehicle is communicated through wireless signal paths 812 and/or 820, respectively, there may be some latency in the signal reaching a processor or controller in the FOD system. Thus, time tₛₜₐᵣₜ may have some “tolerance” in time due to the delay in receiving the accelerometer sensor signal. This tolerance can be determined by the latency of the signal path 812 or 820 (for example, if the signal path used is WiFi or radio, then the latency can be determined by the speed of the WiFi or radio connection). In some embodiments, the tolerance may be set to ±2 seconds of time tₛₜₐᵣₜ. In some embodiments, the tolerance may be less than the time it takes for foreign objects to heat up. In other words, the time it takes to sense a foreign object can be less than the time it takes for the foreign object to heat up. In some embodiments, the tolerance may be determined by the sampling rate of the sensor(s). For example, the inverse of the tolerance (1/seconds) can be less than the sampling rate of the sensor(s).

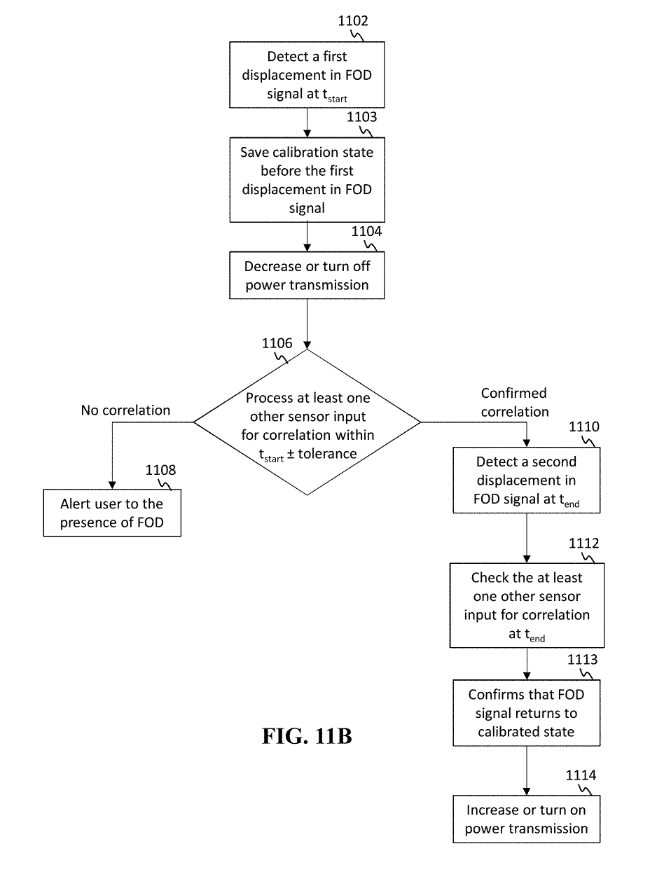

FIG. 10A shows a diagrammatic representation of an exemplary embodiment of a foreign object detection signal when the vehicle (connected to the wireless power receiver) is moved. For example, environmental factors such as wind may cause the vehicle to move or a person may actuate the move by sitting in the vehicle or placing cargo in the vehicle. Note here that the signal is large or significantly displaced compared to the FOD threshold and to the FOD signal in FIG. 9A. FIG. 10B shows a diagrammatic representation of an exemplary embodiment of an output signal from an accelerometer positioned on the vehicle 202. FIG. 10C shows a diagrammatic representation of an exemplary embodiment of an output signal from a sensor positioned on the vehicle or near the wireless power system. Exemplary sensor(s) include motion sensor, accelerometer, gyroscope, radar, optical sensor, ultrasound, LiDAR, inductive sensor, capacitive sensor, thermal sensor, humidity, barometric pressure, anemometer, and/or acoustic sensor. Note that once the vehicle stops moving at time t_{end} (and a displacement in the FOD signal is detected), there may be some delay (time t_{pwr}_{_}ₒₙ-time t_{end}) before power transmission is turned back on at time t_{pwr}_{_}ₒₙ. In other embodiments, power transmission may be turned on at time t_{end}. In some embodiments, the power may not be turned off if the additional sensor measurements, for example, in FIG. 10B or 10C indicate that a false detection of a foreign object. In other embodiments, the power from the transmitter may be reduced to during the time of vehicle movement.

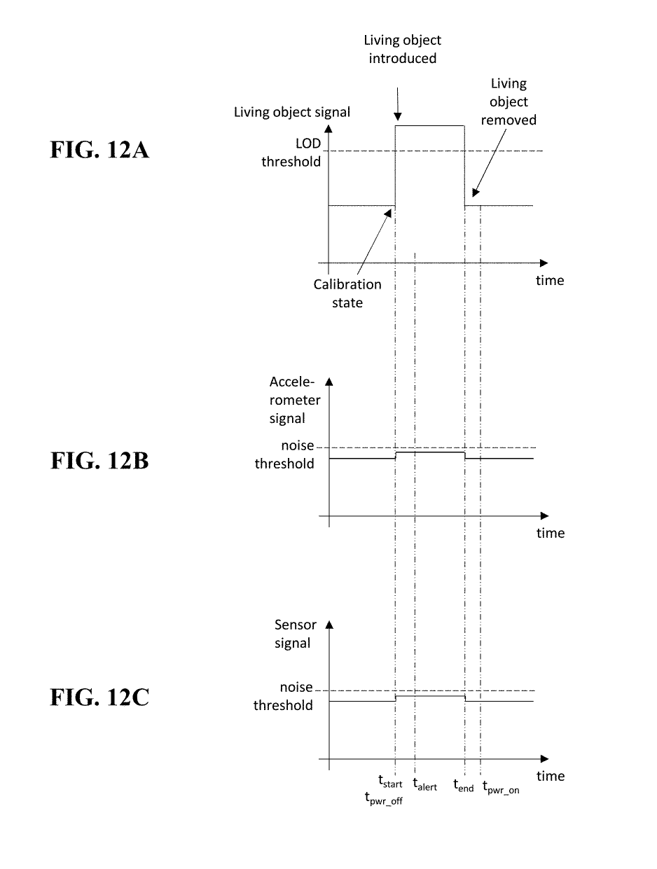

FIG. 11A shows a flowchart of an exemplary embodiment of mitigating false detections of foreign objects positioned proximally to a wireless power system. A processor (which can be part of the FOD system and/or wireless power system) is configured to monitor a FOD signal of the FOD system, such as one or more voltage outputs of the sensor array of the FOD system. This can be continual monitoring or intermittent monitoring. If the processor is in the FOD system, it can be coupled to the sensor array of the FOD system. If the processor is in the wireless power system, the processor can be coupled to the FOD system by way of the connection between the wireless power system and the FOD system. The processor can compare the magnitude of the FOD signal to a FOD threshold to detect any displacements. In some embodiments, the processor can monitor a characteristic of the sensor signal to determine whether the characteristic is a normal value. For the type of sensor for which the magnitude of the signal is primarily monitored (such as a current or voltage signal), the characteristic may be the magnitude and the normal value may be a value compared to a range of values or a threshold. For the type of sensor for which a binary output is expected (for example, for an occupancy signal), a normal value characteristic may be a “0” in which, for example, the passenger is not detected to be in the vehicle. In another example, the characteristic may be a frequency of the signal, and a corresponding normal value may be a particular modulation, pattern, or frequency in a range or multiple ranges.

At step 1102, the processor (for example, of the FOD system) senses a first displacement from the calibration state in the FOD signal at tₛₜₐᵣₜ. A displacement can be, for example, a spike or increase in the FOD signal. In some systems, this may be a decrease in the FOD signal depending on the collected measurements. The calibration state is the calibration data saved before the first displacement occurs. During this time or shortly thereafter, at step 1104, the processor may signal to the wireless power transmitter to decrease or turn off power transmission. For example, a wireless power transmitter may decrease power instead of turning off completely because a return to full or near-full power levels may be too inefficient and a decreased power state may avoid heating the detected object. This inefficiency may be due to the lost charge time or due to the relatively slow ramp up of power transmission. In another embodiment, a power transmitter may decrease power if the foreign object appears to be benign enough to not cause a hazard if power is transmitted at a lower level. Foreign objects that may fit this category are those made of nonconductive materials, such as plastic or wood. Some configurations may turn off power entirely to ensure safety. In some embodiments, if the FOD signal is above the threshold, the processor may signal to the wireless power transmitter to decrease or turn off power transmission. In some embodiments, if a particular subset of FOD sensor coils, or number of coils are affected (see FIG. 7A), the processor can signal to the wireless power transmitter to decrease or turn off power. In some embodiments, if all or a majority of coils are affected (see FIG. 7B), the processor can signal to the wireless power transmitter to decrease or turn off power.

At step 1106, the processor processes data from at least one other sensor and determines if there is a correlation in time to the FOD signal. If, for example, the accelerometer and/or other sensor do not show correlated signals, then the processor can process these signals and, at step 1108, alert the user to the presence of a foreign object. In some embodiments, the processor may communicate with a communication module (which can be a part of the FOD system and/or wireless power system) to alert the user to the presence of the foreign object. If, for example, the accelerometer and/or other sensor show similar timing of sensor signals, the foreign object detection system can process these signals and avoid alerting the user. In some embodiments, the processor can continue to gather data until it senses a second displacement in the FOD signal at time t_{end}. For example, the second displacement can be a decrease in the FOD signal (if the first displacement was an increase). In the example, where the first displacement is a decrease, the second displacement can be an increase in the FOD signal to return within the FOD threshold. In some embodiments, the processor can ensure that the second displacement in the FOD signal is below the FOD threshold.

Optionally, at step 1112, the processor may check at least one other sensor input for a similar correlation at time t_{end}. In step 1114, at time t_{end} or after some delay (time t_{pwr}_{_}ₒₙ-time t_{end}), the processor may signal to the wireless power system to turn power transmission back on at time t_{pwr}_{_}ₒₙ. Note that data that results from any one or more of the monitoring, comparing, receiving, or collecting processes can be stored in a memory of the FOD system and/or wireless power system.

FIG. 11B shows a flowchart of an exemplary embodiment of mitigating false detections of foreign objects. In addition to the steps of FIG. 11A, FIG. 11B includes step 1103 in which the calibration state of the detection system may be saved to the memory of the system. In step 1113, the processor may confirm that the FOD signal has returned to the calibration state before the FOD signal was displaced in step 1102. Note that due to drifting in the overall system, the FOD signal may be near but not exactly at the calibrated measurements from step 1103. In some embodiments, the FOD signal may be accepted as having returned to the calibrated state if the FOD signal is less than the FOD threshold.

In some embodiments, the processor may not rely on a calibration state to determine the presence of foreign object(s). For instance, the processor may measure the displacement as a percentage of the baseline signal and compare the displacement percentage to a threshold. The baseline signal can be any type of signal such as a voltage, current, power, or a processed signal, from one or more sensors of the sensor array. For example, for a given threshold of 15%, a displacement percentage of 23% of the baseline signal would trigger a positive foreign object detection event.

### Living Object Detection Sensor(s)

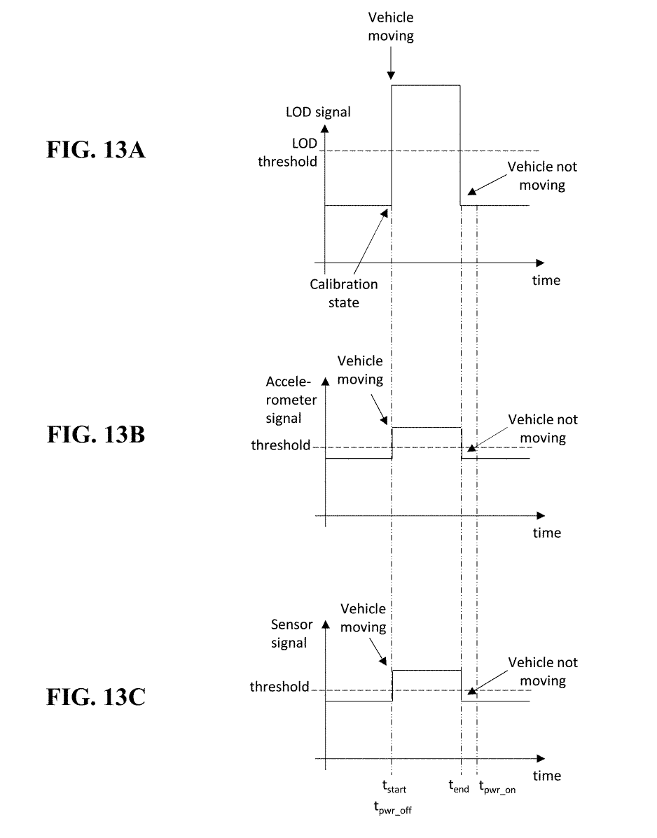

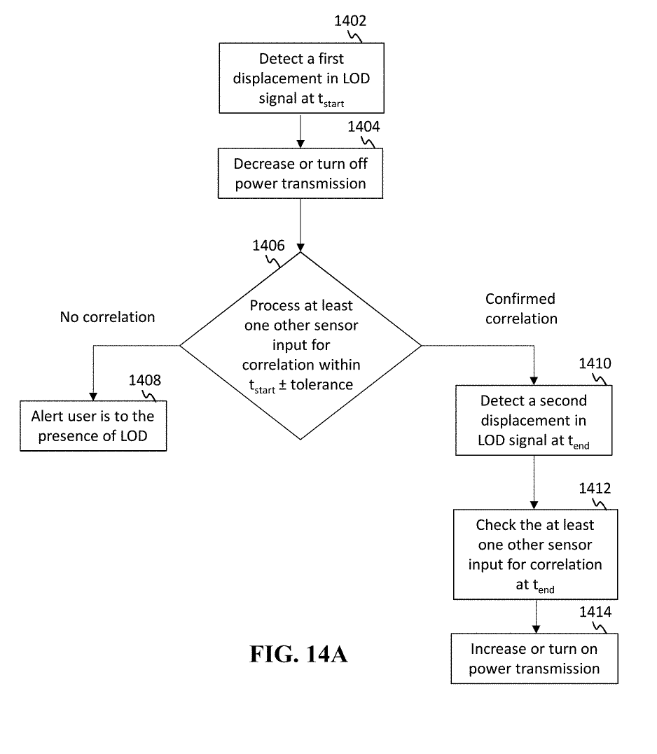

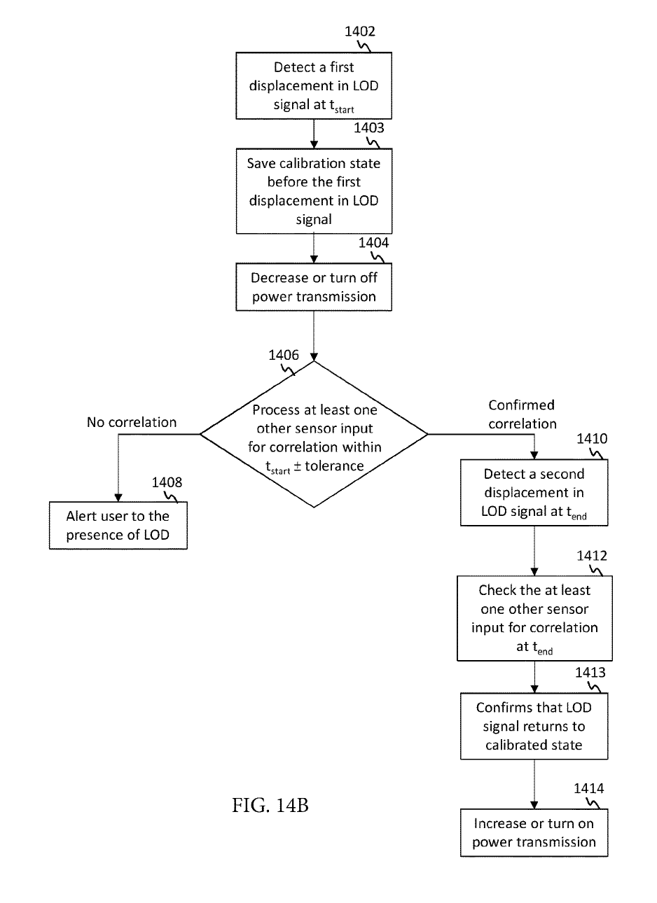

In some embodiments, the sensors of the wireless power system can be multi-purposed to provide input to the FOD system. For example, living object detection (LOD) sensor 822 designed to detect the movement of living objects can be used to also detect the movement of the vehicle. For example, the LOD sensor 822 can be a radar-based system, such as a Doppler radar-based system, to detect movement, and provide input to the detection system via signal path 824. In some embodiments, the detection system can take one or more of these sensor inputs to ensure redundancy such that false detections are not triggered. For example, a vehicle movement (which might create a false FOD detect) would trigger multiple Doppler-radar based sensors monitoring more than one reason under or near the vehicle in a similar way, whereas a moving object that may be of concern might trigger a single Doppler-radar based sensor, or individual sensors at a time. Redundancy can ensure that the user of the system is not unnecessarily alerted, creating a less desirable user experience. In some embodiments, the LOD sensor can be trained such that some movements of the vehicle are not detected by the LOD sensor. This is helpful to avoid false living object detections due to vehicle movement. This can be also helpful to avoid false detections of foreign objects by the living object detection sensors. An additional sensor may assist in mitigating false detection by the LOD system (see FIG. 12A, FIG. 12B, FIG. 12C, FIG. 13A, FIG. 13B, FIG. 13C, FIG. 14A, FIG. 14B). For example, the additional sensor may be an accelerometer located on the wireless power transmitter or on the vehicle and configured to detect movement of the vehicle. It is understood that false positive living object detections can due to other reasons, for example, water dripping from the vehicle or flowing on the ground. These false positive detections can be mitigated by similar training (as discussed above for the exemplary FOD system or accelerator) or by the utilization of supplementary sensors (as depicted in FIG. 13C). The additional sensor may be on or proximate to the wireless power receiver or wireless power transmitter 826, 822, 828, 830 and may be able to contribute to avoiding false detection events by the LOD system, for example, because of water. For example, such a sensor may be a humidity sensor, moisture sensor, capacitance sensor, or optical sensor.

### Mitigating False Detections of Living Objects

Some movements of a vehicle positioned over a wireless power transmitter may trigger a false detection of living objects by a LOD system. Such movements can include shaking, bouncing, leaning, etc. due to wind blowing at the vehicle, people sitting in and/or leaving the vehicle, loading cargo, leaning against the vehicle, and the like. The movement of the vehicle causes the movement of the wireless power receiver (attached to the underside of the vehicle, as illustrated in FIG. 8A) which itself can cause a significant change in the sensor outputs of a movement-based LOD system. The sensor measurements from the sensor array of the LOD system can change and the resulting signal can appear as an unintended living object detection event by the LOD system. In many cases, the vehicle may return to its initial position, i.e., the position it was in before being disturbed by some outside force. While the vehicle itself may not be significantly displaced, the sensitivity of the detection techniques described may cause a “false detection” of living objects in response to these types of movements. It has been shown that the movement of a vehicle is detected by the LOD system by a displacement in the LOD signal, wherein this displacement of the LOD signal may be about similar across a plurality of sensors or all of the sensors. The displacements of the sensors may have a defined gradient across certain sensors.

In some embodiments, a radar-based LOD sensor or a capacitance-based LOD sensor may be sensitive to water and consequently trigger a false detection event. The presence of water may be due to snow melting, water dripping off the vehicle, or water flowing near the LOD sensor(s). An additional sensor (such as sensors 810, 826, 822, 828, and/or 830) on or proximate to the wireless power receiver, may be able to alert to the presence of water. Exemplary sensor(s) include humidity sensor, moisture sensor, capacitance sensor, or optical sensor. The methods described herein may apply to various environment monitoring sensors, various secondary sensors, or any combination of environment monitoring sensors.

### Environment Monitoring and Safety Checks

The objects that can pose a unique threat to the safe and efficient operation of highly-resonant wireless power systems can be detected by sensors and/or sensor systems coupled to or part of an intrusion detection system 102 or environment monitoring system 102. Environment monitoring and safety checks can include, for example, checking for foreign objects, checking for living objects, checking for motion of the vehicle/receiver, and monitoring/checking various other safety systems and operating parameters. If such checks and systems are satisfied, power transfer is initiated from wireless power transmitter to wireless power receiver. The environment monitoring system may perform part of or all of the methods and processing described herein, including controlling power systems and including controlling the various safety and monitoring systems. In some embodiments, the environment monitoring system may send alert(s) to the user. In some embodiments, the environment monitoring system may send a control signal to the inverter of the wireless power transmitter to decrease or turn off power. The environment monitoring system may send a signal to turn off or decrease power (for example, to an inverter of the wireless power transmitter) if any of the environment monitoring and safety signals at the wireless power transmitter or wireless power receiver indicate a fault or unsafe condition (e.g., over-current or over-temperature) or the presence of a foreign or living object. The environment monitoring system may compare the signals to additional sensors and determine if there was a false detection. If the signal that alerted to a fault, unsafe condition, or presence of a living or foreign object was determined to be a false positive or false detection, the environment monitoring system may then send a signal to increase or turn power back on (for example, to an inverter of a wireless power transmitter).

### Detection Improvement through Data Collection and Analysis

An exemplary detection system—or an exemplary wireless power system having a detection system—may be equipped with a memory module, configured to collect data related to detection of objects proximal to the wireless power system, and a communication module, configured to communicate any or all of the data to an external system. In some embodiments, this external system may be a server system configured to collect and/or analyze received data from the detection system or power system.

FIG. 3B shows an exemplary communication path 332 from the detection system to a server system that can transmit data to and from a server system 334. The data can include the number of detection events (including true and/or false positive), the data collected by one or more of the sensors on or near the wireless power system or vehicle, or other data. This data can be collected from deployed systems to improve the functionality of future systems or for the improvement of the deployed systems. For example, through this communication path 332, upgrades to software or firmware of the wireless power system and/or detection system may be actuated. The collected data can be used to configure new systems or already-deployed systems with improved detection, which can include the reduction of false positive detection events.

While the disclosed techniques have been described in connection with certain preferred embodiments, other embodiments will be understood by one of ordinary skill in the art and are intended to fall within the scope of this disclosure. For example, designs, to methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A method for mitigating false detection of a foreign object positioned within a range of a wireless power system configured to transmit power to a load of a vehicle, the method comprising:
monitoring a foreign object detection (FOD) signal of a FOD system, the FOD system coupled to the wireless power system;
comparing a magnitude of the FOD signal to a FOD threshold to detect a first displacement above the FOD threshold, the first displacement occurring at time tₛₜₐᵣₜ;
receiving a first sensor signal from a first sensor positioned within range of the vehicle, the first sensor separate from the FOD system;
monitoring a characteristic of the first sensor signal to determine whether the characteristic is a normal value within time tₛₜₐᵣₜ±tolerance; and
decreasing or turning off power transmission, if the first displacement of the FOD signal magnitude crosses the FOD threshold and if the characteristic of the first sensor signal is a normal value throughout time tₛₜₐᵣₜ±tolerance, from a wireless power transmitter of the wireless power system.

2. The method of claim 1 further comprising:
transmitting an alert to a user of the vehicle, if the first displacement crosses the FOD threshold and if the characteristic of the first sensor signal is a normal value throughout time tₛₜₐᵣₜ±tolerance, wherein the alert includes information about a presence of the foreign object.

3. The method of claim 2 further comprising:
comparing a second displacement in the magnitude of the FOD signal to the FOD threshold, the second displacement occurring after the first displacement of the FOD signal magnitude; and
increasing or turning on power transmission from the wireless power transmitter, if the second displacement of the FOD signal magnitude is less than the FOD threshold.

4. The method of claim 1 wherein the FOD threshold is predetermined.

5. The method of claim 1 wherein an inverse of the tolerance is less than a sampling rate of the FOD system.

6. The method of claim 1 wherein the tolerance is set based on an expected delay in receiving the first sensor signal from the first sensor.

7. The method of claim 6 wherein the delay is determined by WiFi latency of a WiFi module in the wireless power system.

8. The method of claim 1 wherein the first sensor comprises an accelerometer of the vehicle and configured to sense movement of the vehicle, the first sensor signal including accelerometer measurement data, the characteristic being a magnitude of movement of the vehicle.

9. The method of claim 1 wherein the first sensor is an occupancy sensor of the vehicle configured to detect at least one of a door opening, door closing, trunk opening, trunk closing, passenger entering, or passenger exiting, the characteristic being a binary output indicating occupancy in the vehicle.

10. The method of claim 1 wherein the first sensor is a temperature sensor of the wireless power transmitter, the first sensor signal being temperature measurement data, the characteristic being a temperature level.

11. The method of claim 1 wherein the first displacement in the FOD signal magnitude is relative to a calibration state of the FOD system and the calibration state before the first displacement is saved to a memory of the FOD system.

12. The method of claim 1 further comprising:
receiving a second sensor signal from a second sensor positioned within range of the vehicle;
monitoring a characteristic of the second sensor signal from the second sensor within time tₛₜₐᵣₜ±tolerance; and
decreasing or turning off power transmission from a wireless power transmitter of the wireless power system, if (i) the first displacement of the FOD signal magnitude is above the FOD threshold, (ii) the characteristic of the first sensor signal is a normal value throughout time tₛₜₐᵣₜ+/−tolerance, and (iii) the characteristic of the second sensor signal is a normal value throughout time tₛₜₐᵣₜ±tolerance.

13. The method of claim 12 wherein the second sensor is a radar-based sensor configured to detect movement in an environment of the vehicle, the second sensor signal being a current or voltage measurement, the characteristic being a magnitude of the current or voltage measurement.

14. The method of claim 13 wherein the radar-based sensor is a Doppler radar-based sensor.

15. The method of claim 1 further comprising:
storing data related to the first displacement in the FOD signal magnitude to a memory module of the wireless power system; and
transmitting the data related to the first displacement to an external server system.

16. The method of claim 15, further comprising:
storing data related to the displacement of the first sensor signal magnitude of the first sensor in the memory module of the wireless power system; and
transmitting the data related to the displacement of the first sensor signal to an external server system.

17. A system for mitigating false detection of foreign objects positioned within a range of a wireless power system configured to transmit power to a load of a vehicle, the system comprising:
a communication module, coupled to a processor and configured to receive a sensor signal from a sensor positioned within range of the vehicle,
the processor configured to:
monitor a foreign object detection (FOD) signal of a FOD system, the FOD system coupled to the wireless power system;
compare a magnitude of the FOD signal to a FOD threshold to detect a first displacement above the FOD threshold, the first displacement occurring at time tₛₜₐᵣₜ;
monitor a characteristic of the sensor signal to determine whether the characteristic is a normal value throughout time tₛₜₐᵣₜ±tolerance;
and
transmit a control signal to the wireless power transmitter to decrease or turn off power transmission from the transmitter, if the first displacement is above the FOD threshold and the characteristic of the sensor signal is a normal value throughout time tₛₜₐᵣₜ±tolerance.

18. The system of claim 17 wherein the FOD system comprises the processor and communication module.

19. The system of claim 17 wherein the wireless power system comprises the processor and communication module.

20. The system of claim 17 wherein:
the processor is configured to transmit an alarm signal to the communication module, if the first displacement is above the FOD threshold and the characteristic of the first sensor signal is a normal value throughout time tₛₜₐᵣₜ±tolerance, and
the communication module, upon receiving an alarm signal from the processor, is configured to transmit an alert to a user of the vehicle, wherein the alert includes information about a presence of the foreign object.
